(19) United States
(12) Patent Application Publication
(10) Pub. No.: US 2008/0075683 A1
(43) Pub. Date: Mar. 27, 2008

(54) Method for Modifying Fibrous Substrates with Siloxan Copolymers

(75) Inventors: Christian Herzig, Waging (DE); Richard Becker, Burghausen (DE); Willibald Burger, Burghausen (DE); Thomas Hohberg, Grabs (CH)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/570,057

(22) PCT Filed: Jun. 2, 2005
(86) PCT No.: PCT/EP05/05952

§ 371 Date: Dec. 5, 2006

(30) Foreign Application Priority Data
Jun. 11, 2004 (DE) 10 2004 028 322.2

(51) Int. Cl. A61Q 5/12; D06M 15/643; D06M 19/00

(52) U.S. Cl. 424/70.12; 8/115.67; 8/94.1 R

(57) ABSTRACT

Fibrous substrates with exacted properties are copolymer prepared by reacting an Si-H bearing polysiloxane with a compound containing both a hydrosilylatable group and an isocyanate reactive group, followed by reaction with di- or polyisocyanate used at or below the stoichiometric amount of NCO groups.

This invention concerns a method of modifying fibrous substrates with siloxane copolymers, such as the modification of natural or artificial substrates of fibrous structure.

U.S. Pat. No. 5,001,210 describes a method of producing polyurethanes wherein amino-functional siloxane telechelics after reaction with cyclic carbonates are converted with di- or polyisocyanates into the target products. Polyethers are used in the form of diamino polyethers, which are costly compared with polyether diols and monools.

EP-A 1 178 069 describes the preparation of polyether urethane intermediates by reaction of alkenyl polyethers with diisocyanates and addition thereonto of silanes bearing hydrolysis-sensitive groups. Siloxane chain polymers are not obtainable in this way.

Branched polyether siloxanes are known from Chemical Abstracts 136: 38808. Hydrosiloxanes are simultaneously reacted with divinylsiloxanes and allyl polyethers. Excess quantities of polyether remain unattached in the product mixture. The products are used as textile softeners and are free of urethane and urea groups.

U.S. 2003/0032726 and its equivalent WO 02/088209 (A. Andrew Shores) describe a reaction product of (A) polyisocyanate, (B) silicone having a dimethyl polysiloxane segment and one or more isocyanate reactive groups, (C) reactant having one or more isocyanate-reactive groups and one or more ionizable groups, and (D) optionally an organic substance having one or more isocyanate-reactive groups but no ionizable groups, and (E) compound providing the counterion for said ionizable groups, wherein either the silicone (B) or the reactant (C), or both, have a single isocyanate-reactive group. The reaction product is useful as demolding agent, as protective film, hydrophobicizing agent for concrete and masonry or water-repellent coating on paper and textiles.

U.S. 2003/0032751 (A. Andrew Shores) describes a reaction product of (A) polyisocyanate, (B) silicone having a dimethyl polysiloxane segment and one or more isocyanate-reactive groups, (C) reactant having one or more isocyanate-reactive groups and one or more ionizable groups, and (D) optionally an organic substance having one or more isocyanate-reactive groups but no ionizable groups, and (E) compound providing the counterion for said ionizable groups, wherein the average molecular weight of the reaction product is in the range from 600 to 20 000. Uses specified include the same as in U.S. 2003/0032726.

The present invention has for its object to provide siloxane copolymers capable of endowing fibrous substrates, such as natural or artificial substrates of fibrous structure, in particular textile sheet materials, with a soft and also hydrophilic finish. The present invention further has for its object that these siloxane copolymers be obtainable in a simple process and be easy to disperse in water, to be in particular self-dispersing, i.e., capable of forming an emulsion, especially a microemulsion, without use of emulsifiers. We have found that this object is achieved by the invention.

The present invention provides a method of modifying fibrous substrates with siloxane copolymers obtainable by a first step of reacting organopolysiloxanes (1) which have at least one silicon-bonded hydrogen atom per molecule, preferably at least two silicon-bonded hydrogen atoms, with substantially linear algometric or polymeric compounds (2) of the general formula

R¹-(A-CₙH₂ₙ)ₘ-A¹-H (I)
where R¹ is a monovalent optionally substituted hydrocarbyl radical capable of adding Si-H groups in a hydrosilylation reaction, preferably a hydrocarbyl radical having an aliphatic carbon-carbon multiple bond,
A is a bivalent polar organic radical selected from the group consisting of —O—, —C(O)—O—, —O—C(O)—, —O—C(O)—O—, —C(O)—NH—, —NH—C(O)—, urethane radical and urea radical, preferably an oxygen atom —O—,
A¹ is a bivalent polar organic radical selected from the group consisting of —O—, —NH— and —NR′— (where R′ is a monovalent hydrocarbyl radical of 1 to 18 carbon atoms), preferably an oxygen atom —O—,
n is an integer from 1 to 20, preferably 1 to 4 and more preferably 2 or 3,
m is equal to 0 or a positive integer, preferably 5 to 50,
and a second step of reacting
the resulting H-A¹-groups-containing intermediates (4) with organic compounds (5), which have two or more isocyanate groups per molecule.

Preferably, the water content of the compounds (1) and (2) used for preparing the siloxane copolymers of the present invention is less than 2000 weight ppm, preferably less than 1500 weight ppm and more preferably less than 1000 weight ppm, all based on the total weight of compounds (1) and (2).

The water content is based on room temperature (20° C.) and the pressure of the ambient atmosphere (1020 hPa).

The term “fibrous substrates” shall herein comprise all natural or artificial substrates of fibrous structure.

The term “modifying fibrous substrates” shall herein comprise the treatment or impregnation of fibrous substrates in order that their properties may be changed in a desired manner; for example, the fibrous substrates shall be rendered soft and hydrophilic.

The siloxane copolymers of the present invention have a viscosity of preferably 1000 to 100 000 000 mPa·s at 25° C. and more preferably 10 000 to 10 000 000 mPa·at 25° C.

The first step of the process preferably utilizes linear, cyclic or branched organopolysiloxanes (1) constructed of units of the general formula

$${R}_{e} {H}_{f} {SiO}_{\frac{4 - e - f}{2}} , \qquad ( II )$$

where
R in each occurrence may be the same or different and is a monovalent optionally substituted hydrocarbyl radical having 1 to 18 carbon atoms per radical,
e is 0, 1, 2 or 3,
f is 0, 1 or 2,
and the sum total of e+f is 0, 1, 2 or 3,
with the proviso that each molecule has at least one silicon-bonded hydrogen atom and preferably 2 or more silicon-bonded hydrogen atoms.

Preferred organopolysiloxanes (1) have the general formula

H_{g}R_{3-g}Sio(SiR₂O)ₒ(SIRHO)ₚSiR_{3-g}H_{g} (III)

where R is as defined above,
g is 0, 1 or 2,
o is 0 or an integer from 1 to 1500, and
p is 0 or an integer from 1 to 200, with the proviso that each molecule has at least one silicon-bonded hydrogen atom and preferably two or more silicon-bonded hydrogen atoms.

Formula (III) of this invention is to be understood as meaning that the o units of —(SiR₂O)— and the p units of —(SiRHO)— may form any desired distribution in the organopolysiloxane molecule.

It is particularly preferable for g in the formula (III) to be 1, for p in the formula (III) to be 0 and for α,ω-dihydropolydiorganosiloxanes and especially α,ω-dihydropolydimethylsiloxanes to be used as organo-polysiloxanes (1).

The organopolysiloxanes (1) preferably have an average viscosity of 10 to 1000 mPa·s at 25° C., preferably 50 to 1000 mPa·s at 25° C. and more preferably 60 to 600 mPa·s at 25° C.

Examples of R radicals are alkyl radicals, such as methyl, ethyl, n-propyl, isopropyl, 1-n-butyl, 2-n-butyl, isobutyl, tert-butyl, n-pentyl, isopentyl, neopentyl, tert-pentyl, hexyl radicals, such as n-hexyl, heptyl radicals, such as n-heptyl, octyl radicals, such as n-octyl and isooctyl radicals, such as 2,2,4-trimethylpentyl, nonyl radicals, such as n-nonyl, decyl radicals, such as n-decyl, dodecyl radicals, such as n-dodecyl, and octadecyl radicals, such as n-octadecyl; cycloalkyl radicals, such as cyclopentyl, cyclohexyl, cycloheptyl and methylcyclo-hexyl; aryl radicals, such as phenyl, naphthyl, anthryl and phenanthryl; alkaryl radicals, such as o-, m-, p-tolyl radicals, xylyl radicals and ethylphenyl radicals; and aralkyl radicals, such as benzyl, α-phenylethyl and β-phenylethyl.

Examples of substituted R radicals are haloalkyl radicals, such as 3,3,3-trifluoro-n-propyl, 2,2,2,2′,2′,2′-hexafluoroisopropyl, heptafluoroiso-propyl and haloaryl radicals, such as o-, m- and p-chlorophenyl.

The R radical is preferably a monovalent hydrocarbyl radical of 1 to 6 carbon atoms, methyl being particularly preferred.

Examples of R radicals fully apply to R′ radicals.

R¹ is preferably a monovalent hydrocarbyl radical possessing an aliphatic carbon-carbon multiple bond.

Examples of R¹ radicals are alkenyl radicals, such as vinyl, 5-hexenyl, cyclohexenyl, 1-propenyl, allyl, 3-butenyl and 4-pentenyl, and alkynyl radicals, such as ethynyl, propargyl and 1-propynyl.

The R¹ radical is preferably an alkenyl radical, especially (ω-alkenyl, and allyl is particularly preferred.

Preference for use as algometric or polymeric compounds (2) is given to aliphatic unsaturated alcohols of the general formula

H₂C=CH=R²-(OCₙH₂ₙ)ₘ-OH (IV)

where R² is a bivalent hydrocarbyl radical of 1 to 20 carbon atoms, preferably a radical of the formula —CH₂13 , —CH(CH₃)— or —C(CH₃)₂— and n and m are each as defined above.

Preferred examples of polyethers (2) are those of the general formula

H₂C=CH—R²—(OCH₂CH₂)ₐ[OCH₂CH(CH₃)]_{b}—OH (IV′)

where R² is as defined above and
a and b is 0 or an integer from 1 to 200, with the proviso that the sum total of a+b is not less than 1 and preferably from 5 to 50.

Further examples of algometric or polymeric compounds (2) are unsaturated polyesters, such as H₂C=CH—R²—[(O)CCₙH₂ₙ]ₘ—OH, unsaturated polycarbonates, such as H₂C=CH—R [OC(O)OCₙH₂ₙ]ₘ—OH, and unsaturated polyamides, such as H₂C=CH—R₂[NHC(O)CₙH₂ₙ]ₘ—NH₂, where R², n and m are each as defined above. Preference for use as monomeric compound (2) is given to unsaturated compounds of the formula

H₂C=CH—R²—OH,

where R² is as defined above and preferably in this case a radical of the formula

—(CH₂)ₙ—

where n is as described. Preferred monomeric compounds (2) are allyl alcohol, 5 hexenol and 7-octenol.

The amounts in which the compounds (2) are used in the first step are preferably in the range from 1.0 to 4.0 and preferably from 1.3 to 2.5 mol of R¹ radical, which is preferably a radical having an aliphatic carbon-carbon multiple bond and preferably is an (ω-alkenyl radical, per gram atom of silicon-bonded hydrogen in organopolysiloxane (1). Monomeric compound (2) used in excess can either be left in the reaction mixture or be removed, partly or wholly, by distillation, if its volatility allows it.

The first step preferably utilizes catalysts (3) to promote the addition of silicon-bonded hydrogen onto aliphatic unsaturation. Useful catalysts (3) for the process of the present invention include the same catalysts as hitherto used to promote the addition of silicon-bonded hydrogen onto aliphatic unsaturation. The catalysts are preferably a metal from the group of the platinum metals or a compound or complex from the group of the platinum metals. Examples of such catalysts are metallic and finely divided platinum, which may be on supports, such as silicon dioxide, aluminum oxide or activated carbon, compounds or complexes of platinum, such as platinum halides, examples being PtCl₄, H₂Ptcl₆*6H₂O, Na₂PtCl₄*4H₂O, platinum-olefin complexes, platinum-alcohol complexes, platinum-alkoxide complexes, platinum-ether complexes, platinum-aldehyde complexes, platinum-ketone complexes, including reaction products of H₂Ptcl₆*6H₂O and cyclohexanone, platinum-vinylsiloxane complexes, such as platinum-1,3-divinyl-1,1,3,3-tetramethyldisiloxane complexes with or without detectable inorganically bound halogen, bis(gammapicoline)platinum dichloride, trimethylenedipyridineplatinum dichloride, dicyclopentadieneplatinum dichloride, dimethyl-sulfoxideethyleneplatinum(II) dichloride, cycloocta-dieneplatinum dichloride, norbornadieneplatinum dichloride, gamma-picolineplatinum dichloride, cyclo-pentadieneplatinum dichloride, and also reaction products of platinum tetrachloride with olefin and primary amine or secondary amine or primary and secondary amine, such as the reaction product of platinum tetrachloride dissolved in 1-octene with sec-butylamine or ammonium-platinum complexes.

The amount in which catalyst (3) is used in the first step is preferably in the range from 1 to 50 weight ppm (parts by weight per million parts by weight) and more preferably in amounts of 2 to 20 weight ppm, all reckoned as elemental platinum and based on the total weight of organopolysiloxanes (1) and compounds (2).

The first step of the process is preferably carried out at the pressure of the ambient atmosphere i.e., at 1020 hPa absolute, say, but can also be carried out at higher or lower pressures. Furthermore, the first step of the process is preferably carried out at a temperature in the range from 60° C. to 140° C. and more preferably at a temperature in the range from 80° C. to 120° C.

The second step of the process preferably utilizes organic compounds (5), which have two or more isocyanate groups per molecule, that have the general formula

O=C=N—R³—N=C=O (V)

where R³ is a bivalent hydrocarbyl radical having 4 to 40 carbon atoms per radical.

Examples of organic compounds (5) are hexamethylene 1,6-diisocyanate, isophorone diisocyanate, tolylene 2,4-diisocyanate, tolylene 2,6-diisocyanate, phenylene 1,3-diisocyanate, 4,4′-methylenebis(cyclohexyl iso-cyanate), 4,4′-methylenebis(phenyl isocyanate) and dimethylphenyl diisocyanate.

The amounts in which organic compounds (5) are used in the second step are preferably in the range from 0.5 to 1.0 mol and more preferably in the range from 0.8 to 1.0 mol of isocyanate group per mole of H-A¹ group in the intermediate (4).

U.S. 2003/0032726 and U.S. 2003/0032751, both previously cited at the beginning, have polyisocyanate always being used in distinct excess, in contrast to the process of the present invention. In fact, there is active counseling in the two US references against the use of smaller quantities because they increase the viscosity of the product, making it difficult to handle and necessitating a solvent. There is consequently a distinct prejudice against the present invention's use of polyisocyanate (5) in a deficiency of 0.5 to 1.0 mol.

The reaction in the second step of the process according to the present invention preferably utilizes condensation catalysts (6), such as di-n-butyltin dilaurate, tin(II) octoate, dibutyltin diacetate, potassium octoate, zinc dilaurate, bismuth trilaurate or tertiary amines, such as dimethylcyclohexylamine, dimethylaminopropyldipropanolamine, pentamethyldipropylenetriamine, N-methylimidazole or N-ethylmorpholine.

A preferred siloxane copolymer is obtained by a first step of reacting an α,ω-dihydropolydiorganosiloxane (1) in excess with a polyether (2) of the formula (IV) and a second step of reacting the intermediate (4), an HO-polyether-polysiloxane-polyether-OH, with a diisocyanate (5) of the formula (V) to introduce urethane groups into the siloxane copolymer. In the process, free polyether from the 1st step is also bound by urethane formation:

CH₂=CH-R²(OCₙH₂ₙ)ₘ-OC(O)NH-R³-NHC(O)O [(CₙH₂ₙO)ₘ-R²-CH₂CH₂-R₂SiO(R₂SiO)O-R₂SiO-CH₂CH₂-R²-(OCₙH₂ₙ)ₘ-OC(O)NH-R³-NHC(O)O]×(CₙH₂ₙO)ₘ-R²-CH=CH₂ (VI),

where R, R², R³, n, m and o are each as defined above and
x is 0 or an integer from 1 to 20, preferably 0 or an integer from 1 to 4.

The urethane groups in the hydrophilic siloxane copolymers of the present invention can act as donors and acceptors in the formation of hydrogen bonds.

The second step of the process according to the present invention, in addition to the organic compounds (5), may utilize still further compounds (7) which are reactive toward isocyanate groups. Examples of further compounds (7) are those selected from the group of formulae

R⁴-(A-CₙH₂ₙ)ₘ-A¹-H (VII),

HO-R⁵-NR⁴-R⁵-OH (VIII),

HO-R⁵-NR⁴₂ (IX),

HO-R⁶ (NR⁴₂)₂ (X),

HO-R⁷-(NR⁴₂)₃ (XI),

(HO)₂R⁶-NR⁴₂ (XII),

HNR⁴₂ (XIII)

where R⁴ is a hydrogen atom or an R radical which may optionally contain one or more nitrogen atoms,
R⁵ is a bivalent hydrocarbyl radical having 1 to 10 carbon atoms per radical,
R⁶ is a trivalent organic radical having 1 to 100 carbon atoms per radical, preferably a trivalent hydrocarbyl radical having 1 to 100 carbon atoms, which contains one or more oxygen atoms,
R⁷ is a tetravalent organic radical having 1 to 100 carbon atoms per radical, preferably a tetravalent hydrocarbyl radical having 1 to 100 carbon atoms which contains one or more oxygen atoms, and A¹, n and m are each as defined above.

Examples of compounds of the formula (VII) are methylpolyethylene oxide, butylpolyethylene oxide, methylpolyethylene oxide/polypropylene oxide and methylpolypropylene oxide.

Examples of compounds of the formula (VIII) are N-methyldiethanolamine, N-methyldipropanolamine, dimethylaminopropyldipropanolamine, N-dodecyldiethanol-amine and N-stearyldipropanolamine.

Examples of compounds of the formula (IX) are N,N-dimethylethanolamine, N,N-diethylpropanolamine, N,N-dimethylaminopropylmethylethanolamine and dimethyl-2-(2-aminoethoxy)ethanol.

Examples of compounds of the formula (X) are 1,5-bis(dimethylamino)pentan-3-ol, 1,5-bis(methylamino)-pentan-3-ol, 1,7-bis(dimethylamino)heptan-4-ol and N,N-bis(3-dimethylaminopropyl)-N-isopropanolamine.

Examples of compounds of the formula (XI) are 2,4,6-tris(dimethylaminomethyl)phenol, 1,1,1-tris(dimethyl-aminomethyl)methanol and 2,4,6-tris(dimethylamino-methyl)cyclohexanol.

Examples of compounds of the formula (XII) are N,N-bis(dimethylaminopropyl)-3-aminopropane-1,2-diol, N,N-bis(dimethylaminopropyl)-2-aminopropane-1,3-diol, N,N-bis(3-dimethylaminopropyl)carbaminomonoglyceride.

Examples of compounds of the formula (XIII) are dibutylamine, octylamine, benzylamine, 3-(cyclohexyl-amino)propylamine, 2-(diethylamino)ethylamine, dipropylenetriamine, isophoronediamine, dimethylamino-propylmethylamine, aminopropylmorpholine, N,N-bis(di-methylaminopropyl)amine, dimethylaminopropylamine.

Compounds of the formula (VIII) to (XIII) provide a way of incorporating protonatable nitrogen in the siloxane copolymer.

Compounds of the formula (VII) are used in the second step in amounts of preferably 0 to 2 mol and more preferably 0 to 1 mol of H-A¹ group per mole of H-A¹ group in compound (2).

Compounds of the formula (VIII) are used in the second step in amounts of preferably 0 to 2 mol and more preferably 0 to 1 mol of HO group per mole of H-A¹ group in compound (2).

Compounds of the formula (IX) are used in the second step in amounts of preferably 0 to 2 mol and more preferably 0 to 1 mol of HO group per mole of H-A¹ group in compound (2).

Compounds of the formula (X) are used in the second step in amounts of preferably 0 to 2 mol and more preferably 0 to 1 mol of HO group per mole of H-A¹ group in compound (2).

Compounds of the formula (XI) are used in the second step in amounts of preferably 0 to 2 mol and more preferably 0 to 1 mol of HO group per mole of H-A¹ group in compound (2).

Compounds of the formula (XII) are used in the second step in amounts of preferably 0 to 2 mel and more preferably 0 to 1 mol of HO group per mole of H-A¹ group in compound (2).

Compounds of the formula (XIII) are used in the second step in amounts of preferably 0 to 2 mol and more preferably 0 to 1 mol of HN group per mole of H-A¹ group in compound (2).

Polyisocyanate (5) is preferably used in deficiency—even in the presence of compounds (7)—to ensure that all the isocyanate groups, which represent a health hazard, will safely react. The amounts in which organic compounds (5) are used in the second step are therefore preferably in the range from 0.5 to 1.0 mol, more preferably in the range from 0.8 to 1.0 mol of isocyanate group per mole of the sum total of isocyanate-reactive functions from the sum total of intermediate (4) and compounds (7).

The second step is preferably carried out at the pressure of the ambient atmosphere, i.e., at 1020 hPa (absolute), say, but can also be carried out at higher or lower pressures. Furthermore, the second step is preferably carried out at a temperature in the range from 40° C. to 140° C. and more preferably at a temperature in the range from 60° C. to 100° C.

To reduce the in some instances very high product viscosities, low molecular weight materials, such as alcohols or ethers, can be added if appropriate. Examples thereof are ethanol, isopropanol, n-butanol, 2-butoxyethanol, diethylene glycol monobutyl ether, tetrahydrofuran, diethylene glycol diethyl ether and dimethoxyethane, of which diethylene glycol monobutyl ether is a preferred example. Preferred quantities added in the case of very viscous products are up to 50% by weight and more preferably up to 30% by weight, based on the hydrophilic siloxane copolymers of the present invention. Such additions also have the advantage that the resultant products are easier to disperse in water than the pure siloxane copolymers.

The siloxane copolymers of the present invention are easy to disperse in water without further auxiliaries, such as emulsifiers, i.e., are self-dispersing, and produce emulsions and especially microemulsions.

The present invention's method of modifying fibrous substrates preferably utilizes the siloxane copolymers of the present invention in the form of their aqueous emulsions, preferably aqueous microemulsions, containing
(A) siloxane copolymers according to the present invention and
(B) water.

The emulsion's content of the present invention's siloxane copolymers (A) is preferably in the range from 20% to 60% and more preferably in the range from 30% to 50% by weight.

The emulsions, preferably microemulsions, of the present invention are produced by mixing of
(A) siloxane copolymers according to the present invention, with
(B) water.

Technologies for producing silicone emulsions are known. Silicone emulsions are typically produced by simply stirring the siloxane copolymers of the present invention with water and if appropriate subsequent homogenization with rotor-stator homogenizers, colloid mills or high pressure homogenizers.

The siloxane copolymers of the present invention or their emulsions can be used in the household sector as hydrophilic softeners applied in the final rinse cycle of a washing machine, in the cosmetics industry as a constituent of hair shampoo, haircare and conditioner formulations, in the textile sector for finishing wovens, fibers or else leather with hydrophilic softeners, and also as hydrophilic softeners for non-wovens. The individual forms of application are more particularly described hereinbelow.

The washing and cleaning of laundry in aqueous wash liquors is a complex process requiring the cooperation of numerous physical and chemical influences. In general, washing can be defined not only as the removing of sparingly soluble materials from textile surfaces by means of water or surfactant solutions but also as the dissolving away from such surfaces of water-soluble soiling.

A machine wash exposes textiles to significantly more mechanical stress than a hand wash. Thus, laundry washed in a washing machine can become compressed so severely that the stacks of fiber on the textile surface are brought into a state of severe disorder, in particular in the case of natural fibers such as cotton or wool. Repeated drying in still air (especially when washing is hung up indoors to dry) causes these conditions to become fixed in the wovens, and the washing acquires a harsh hand.

As well as softening there are other desirable effects beneficial to laundry care and wear comfort. They include, for example, facilitating ironing by reducing the friction between the iron and the textile surface. Similarly, the reduction of wrinkles, which reduces the need for ironing, as well as protection against wrinkling are desired effects. Such additional effects, however, should ideally be achieved without reducing the hydrophilicity of the textiles.

To achieve said effects, active components in the form of liquid fabric conditioners are added to the last rinse cycle. Cationic surfactants based on quaternary ammonium compounds can improve softness for example.

Laundry detergent manufacturers would of course also be interested in introducing the additional effects described in the course of the actual washing process, in the form of “2-in-1” products. However, successful use of such products requires counteracting the competition in the washing process with regard to the desorption of soiling and the adsorption of active components which is necessary for textile effects. In this direction, hitherto no marketable products capable of satisfying the consumer have been developed. The siloxane copolymers of the present invention solve this problem.

The siloxane copolymers of the present invention can be made, depending on the choice of stoichiometry, water-soluble or self-emulsifying (so-called “self-emulsifying systems”), i.e., they require no further, auxiliary agents for emulsification. The siloxane copolymers can be used for treating textile sheet materials, textile fibers and leather, as additives in coatings and paints, as inclusions in cosmetic formulations and as surface-active agents. They have, in particular, excellent properties when used as textile softeners, which are superior to those of customary amino-glycol oils.

Owing to their cationogenicity and polarity, due to the number of amino, carbamide and urea groups in the molecule, the copolymers of the present invention adhere very effectively to substrates such as textiles or paper, and combine their hydrophilicity, which is comparatively high for organosilicon compounds, with outstanding improvement in hand. Compared with the prior art amino-functional, glycol-functional, amido-functional and aminoglycol-functional hand-modifying products, the copolymers of the present invention are notable for improved ability to exhaust, durability to washes and dry cleaning, improved bondability, stability to shearing forces and pH changes and preparability of synergistic formulations.

The siloxane copolymers can therefore be used for example as constituents of emulsions, in solution or solventlessly for the treatment of textile sheet materials, for example wovens, knits or tiles, for textile fiber and yarn finishing and modification and also for leather and paper treatment. Finishing or modifying with the appropriate siloxane copolymers can be used to confer desired properties such as for example a soft, supple hand, improved elasticity, antistatic properties, color deepening, coefficients of friction, surface smoothness, luster, crease recovery, color fastnesses, durability to laundering, hydrophilicity, tongue tear strength, reduced tendency to pill, easy care and soil release properties and also improved wear comfort. The effects achieved through finishing with the siloxane copolymers exhibit good to very good durability to washing and reconditioning operations, depending on the structure of the siloxane copolymers, of the substrate and of the washing conditions.

The finishing or modification of textile sheet materials, fibers, yarns, paper and leather with the siloxane copolymers can further be used to improve the industrial processibility, for example the processing and manufacturing speed, possibilities for correction and also the quality of the materials.

The textile sheet materials, fibers and yarns may have been fabricated from mineral fibers, such as glass fibers or silicate fibers, natural fibers such as for example wool, silk or cotton, manufactured fibers, such as for example polyester or polyamide fibers, cellulose fibers, copolymer fibers or metal fibers. Filament fibers or staple fibers composed of the substrates mentioned can likewise be used. It is further possible to use sheet materials composed of fiber blends, such as cotton-polyester, paper and also natural sheet materials, such as leather.

The coating or finish can be applied in the knife coating process, dip (squeeze) process, extrusion process, spraying, flocking or atomizing process, padding, exhaust or dip-whiz process. Similarly, all varieties of roller coatings, such as gravure roll, kiss roll or application by multiroll systems, and also printing, for example (rotary) screen printing, are possible. Finishing or coating can further be carried out by foam application and subsequent calendering, using a calender including a hotmelt calender.

The siloxane copolymers can further be used as additives in coatings, paints and glazes. Additions of the siloxane copolymers to radiation- or addition-curing coatings lead to a reduction in the surface roughness and thus to a reduction in the slip resistance of the coating.

The siloxane copolymers can further serve as inclusions in cosmetic formulations, for example as conditioners in hair-washing agents, and also as building protectants.

In addition, the siloxane copolymers constitute surface-active agents and can be used as detergents, surfactants, emulsifiers, defoamers and foam stabilizers.

Preparation of inventive siloxane copolymers and aqueous emulsions thereof:

### Example 1

491 g of an α, ω-dihydropolydimethylsiloxane having 0.055% by weight of silicon-bonded hydrogen and a water content of 50 weight ppm are mixed with 1001 g of an allyl alcohol ethoxylate/propoxylate of the formula

H₂C=CH-CH₂-(OCH₂CH₂)ₐ[OCH₂CH (CH₃) ]_{b}-OH,

having an a:b ratio=1.0, a water content of 978 weight ppm and an iodine number of 13.7 (the iodine number indicates the amount of iodine, in grams, consumed in the course of the addition onto the aliphatic unsaturation per 100 grams used of material to be investigated), and the mixture is heated to 100° C. and then has metered into it 0.28 g of a 2.7% by weight (based on elemental platinum) solution of a platinum 1,3-divinyl-1,1,3,3-tetramethyldisiloxane complex in an α,ω-divinyldimethylpolysiloxane having a viscosity of 1000 mPa·s at 25° C., a solution of Karstedt's catalyst (the preparation of which is described in U.S. Pat. No. 3,775,452). The temperature of the reaction mixture rises by about 6° C., whereupon the same amount of catalyst is metered in again. The reaction mixture then turns homogeneous. After an hour's reaction time at 100 to 110° C., a sample of the polyether-polysiloxane intermediate is cooled down and found to have a viscosity of 2220 mm²/s at 25° C.

45.5 g of hexamethylene 1,6-diisocyanate (1.0 mol of isocyanate group per mole of HO group in the intermediate) are then metered in at 100° C., and urethane formation is catalyzed with 100 mg of di- n-butyltin dilaurate. After two hours at 100° C., the clear reaction product is cooled down. Its viscosity is about 100 000 mPa·s at 25° C.

40 g of the highly viscous oil are mixed with 60 g of water at 50° C. The product is readily emulsifiable and forms an opalescent microemulsion having a urethane content of 0.14 meq./g.

### Comparative Experiment

Example 1 is repeated mutatis mutandis except that for comparison a different batch of the polyether is used, this batch containing 3620 ppm of water from its method of production. In terms of the entire batch, the water content is now 2350 ppm of water instead of 636 ppm.

The reaction with hexamethylene 1,6-diisocyanate is accompanied by severe foaming. After the reaction has ended, a barely stirrable oil is obtained which, after incorporation of 1.5 times the amount of water (40% oil content), does not spontaneously form an emulsion. Prolonged application of high-shearing forces using a Turrax leads to the formation of a cloudy, inhomogeneous mixture.

### Example 2

960 g of the α,ω-dihydropolydimethylsiloxane having a water content of 50 weight ppm from Example 1 are mixed with 536 g of a polyether of the formula

H₂C=CH-CH₂-(OCH₂CH₂)_{10.2}-OH,

having a water content of 686 weight ppm, and heated to 100° C. 0.28 g of Karstedt's catalyst solution described in Example 1 is then added, whereupon the temperature of the reaction mixture rises to 19° C. and a clear product is formed. Complete conversion of the silicon-bonded hydrogen is achieved after one hour at 100 to 110° C. The polyether-polysiloxane intermediate has a viscosity of 760 mm²/s at 25° C.

63 g of N-methyldiethanolamine (1.02 mol of HO group per mole of HO group in the polyether) and 178 g of hexamethylene diisocyanate (0.99 mol of isocyanate group per mole of the sum total of HO groups in the intermediate and the N-methyldiethanolamine) are then meteringly added in succession. Urethane formation is catalyzed with 100 mg of di-n-butyltin dilaurate. After the batch has been held at 100° C. for 2 hours it is cooled down and 64 g of acetic acid are added at 70° C. The clear, brownish product has a viscosity of 120 000 mPa·s at 25° C.

40 g of the highly viscous oil are mixed with 60 g of water at 50° C. Gentle stirring produces a microemulsion having a urethane content of 0.39 meq./g and an amine number of 0.12 (the amine number is the number of ml of 1N HCl needed to neutralize 1 g of substance).

### Example 3

1411 g of the allyl alcohol ethoxylate/propoxylate of Example 1 are mixed with 813 g of an α, ω-dihydropolydimethylsiloxane having 0.052% by weight of silicone-bonded hydrogen and heated to 100° C. with thorough stirring. Identical catalysis provides a polyether-polysiloxane intermediate having a viscosity of 2490 mm² /s at 25° C. after a reaction time of one hour.

At 100° C., 83 g of N,N-bis(3-dimethylaminopropyl)-N-isopropanolamine are stirred in and 92 g of hexamethylene diisocyanate are metered in. The ratio of NCO groups to the sum total of NCO-reactive organic groups is 0.995 or, taking into account the water present therein, just 0.87. A somewhat exothermic reaction is followed by heating to 120° C., at which point 50 mg of dibutyltin laurate are added and the reaction is allowed to proceed for a further 3 hours until isocyanate is no longer detectable in the IR, while the viscosity increases at the same time. The oil, which is very viscous at 25° C., has a basic nitrogen content of 0.42 meq./g.

### Example 4

635 g of the α,ω-dihydropolydimethylsiloxane of Example 3 are reacted with 205 g of a polyether of the formula

H₂C=CH-CH₂-(OCH₂CH₂)_{9.5}-OH,

as in Example 2. The polyether-polysiloxane intermediate has an OH concentration of 0.512 meq./g and contains 177 ppm of water.

200 g of this intermediate are mixed with 10.3 g of bis(dimethylaminopropyl)amine and heated to 84° C.; 13.2 g of hexamethylene diisocyanate are metered in. The ratio of NCO groups to the sum total of NCO-reactive organic functions is 0.998 or, if water is included, 0.97.

Complete conversion of the isocyanate groups is achieved in one hour at about 90° C. in a slightly exothermic reaction without further catalysis. The polymer mixture contains 0.49 meq. of basic nitrogen per gram.

32 g of this polymer are neutralized with a solution of 1.04 g of acetic acid in 8 g of diethylene glycol monobutyl ether. A slightly yellowish microemulsion forms spontaneously with 60 g of water after stirring with a spatula.

### Example 5

200 g of the polyether-polysiloxane intermediate prepared in Example 4 (0.512 meq. of OH/g) are admixed with an additional 26.2 g of the polyether used in the synthesis of the intermediate and also with 14.8 g of bis(dimethylaminopropyl)amine and heated to 80° C. The addition of 19.8 g of hexamethylene diisocyanate immediately starts a moderately exothermic reaction, which ends after about 2 hours at 90° C., and isocyanate is no longer detectable. The ratio of NCO to the sum total of NCO-reactive groups (OH, NH) is 0.995 when water is not included and only 0.97 when the water present therein is included.

The highly viscous polymer mixture has a basic nitrogen concentration of 0.60 meq./g.

A microemulsion is produced by neutralizing 32 g of this product with a solution of 1.29 g of acetic acid in 8 g of diethylene glycol monobutyl ether and then adding 60 g of water with stirring.

### Example 6

200 g of the polyether-polysiloxane intermediate prepared in Example 4 (0.512 meq. of OH/g) and just 4.5 g of bis(dimethylaminopropyl)amine are heated to 88° C. without further additions of polyether. The addition of 10.6 g of hexamethylene diisocyanate starts a slightly exothermic reaction. The ratio of NCO groups to the sum total of NCO-reactive organic functions is 0.998 or, having regard to the water present in the reaction mixture, 0.97.

Isocyanate is no longer detectable after 1 hour at 100° C. The highly viscous polymer has a basic nitrogen content of 0.22 meq./g.

A stable microemulsion is obtained by neutralizing 32 g of basic product with a solution of 0.46 g of acetic acid in 8 g of diethylene glycol monobutyl ether and adding 60 g of water with stirring.

### Example 7

Example 2 is repeated mutatis mutandis replacing the N-methyldiethanolamine in stage 2 by 99 g of bis(dimethylaminopropyl)amine. The amount of hexamethylene diisocyanate is reduced to 131 g (0.98 mol of isocyanate per mole of the sum total of isocyanate-reactive OH and NH groups). Following complete conversion of all isocyanate groups, the batch is neutralized with 70 g of acetic acid and diluted with 450 g of diethylene glycol monobutyl ether. At a polymer content of 80%, this solution has a viscosity of 4900 mm²/s at 25° C. and an amine number of 0.47. A total of 60 g of water is stirred a little at a time into 40 g of this solution at room temperature to form a fine emulsion having an amine number of 0.19.

### Example 8

Compared with Example 7, this example utilizes reduced amounts of raw materials which are monofunctional with regard to isocyanate. The polyether is reduced from 536 g to 402 g and the amine from 99 g to 50 g.

Accordingly, the reaction mixture contains 1.06 mol of isocyanate-reactive groups, which reduces the amount of hexamethylene diisocyanate to 87 g. Neutralization is effected with 35 g of acetic acid. Diluting with 384 g of diethyleneglycol monobutyl ether gives a clear 80% amino PUR silicone polyether solution of 5100 mm²/s (25° C.), which has an amine number of 0.28. This solution is emulsified similarly to Example 7. The fine emulsion formed has an amine number of 0.113.

### Example 9

960 g of the α, ω-dihydropolydimethylsiloxane of Example 1 are reacted with 125 g of a polyether of the formula

H₂C=CH-CH₂-(OCH₂CH₂)_{3.0}-OH

having a water content of 780 weight ppm, as described there. After complete conversion of the silicon-bonded hydrogen, the product is heated at 140° C. under reduced pressure to obtain 1060 g of a clear α,ω-dihydroxysiloxane copolymer. 70 g of bis(dimethylaminopropyl)amine and 74 g of hexamethylene diisocyanate are added thereto in succession at 100° C. After two hours at 100° C., all the NCO groups have reacted, and the batch is neutralized with 49 g of acetic acid and diluted with 313 g of diethylene glycol monobutyl ether for simpler handling. The 80% formulation has a viscosity of 2200 mm²/s (25° C.) and an amine number of 0.35.

The emulsification similarly to Example 7 gives a fine emulsion of amine number 0.14.

### Example 10

1492 g of the polyether polysiloxane intermediate of Example 1 are mixed with 51 g of bis(dimethylamino-propyl)amine and 67 g of hexamethylene diisocyanate at 100° C. The slightly exothermic reaction gives complete conversion of the NCO groups after two hours. Neutralization with 35 g of acetic acid and further dilution with 410 g of diethylene glycol monobutyl ether gives a clear formulation having a viscosity of 7800 mm²/s (25° C.) and an amine number of 0.26.

60 g of water are easily stirred into 40 g of this dilution. The aqueous formulation has an amine number of 0.104.

### Use of Inventive Siloxane Copolymers:

### Example 11

### Use as Rinse Cycle Softener

Eight terry towels (225 g), 8 flat woven cotton cloths (20×160 cm, 50 g) and 8 flat woven blend fiber cloths (15×100 cm, 45 g) at a time are washed twice with 130.0 g of silicone-free fully built washing powder in the full wash cycle at 95° C. Thereafter, the fabrics are rinsed twice more by starting the rinse cycle. To treat the fabrics with the siloxane copolymers of the present invention, one terry towel, one flat woven cotton cloth and one flat woven fiber blend cloth were put together in the washing machine and the first rinse cycle started with completely ion-free water. On starting the third and last rinse cycle, the porthole of the washing machine is opened and the drum is entered with 1.5 l of tap water for a resulting water hardness of 30 German hardness and also 5 g of glacial acetic acid for a pH of 4. Then, 10.16 g of inventive silicone emulsion according to Examples 7-9, corresponding to 1.0% of active silicone, on weight of fiber, are put into the drum in each case and the last rinse cycle is started. After the fabrics have been air dried and conditioned at 23° C. and 60% relative humidity overnight they are subjected to performance tests.

Softness is determined by a jury of testers. The terry towels are numbered from 1 to n. Each tester compares—blind—towel 1 with towel 2. If towel 1 is softer, it is rated 1; if it is harsher, it is rated 0; and if the two towels are rated the same they are both awarded 0.5. Then, towel 1 is compared with 3, 1 with 4, etc., through to the comparison of towel n-1 with n. All the ratings for a towel are added together and reported as the result. The jury shall have three members at least.

In the ironing test, the flat woven cotton and fiber blend cloths are ironed without steam on the cotton setting, while counting the number of times the iron has to pass over a piece of fabric to iron the fabric crease free.

In the rewetting test, a drop of blue completely ion-free water is dripped onto the fabric from a height of 1 cm and the time is taken until the drop has been absorbed to such an extent that the first structures in the fabric become visible in the area which was wetted.

In the skid test, a hot iron on the cotton setting without steam is allowed to glide down the fabric at an angle of 6°. The time needed for a skid of 90 cm is taken.

The results of the performance tests are summarized in Table 1.

TABLE 1

| | | | | Skid test |
|---|---|---|---|---|
| Silicone | Softness | Rewetting | Skid test | (fiber |
| emulsion of | (terry) | (terry) | (cotton) | blend) |
| Blank value | 0 | 1 s | >60 s | 10 s |
| (untreated) | | | | |
| Example 8 | 1.7 | 2 s | 10 s | 8 s |
| Example 7 | 1.0 | 1 s | 15 s | 10 s |
| Example 9 | 3.0 | 1 s | 5 s | 4 s |

Compared with untreated terry towels, softness is appreciably improved by the siloxane copolymers of the present invention without noticeable deterioration in water absorption. The skid tests give significantly better results.

### Example 12

### Use as a Softener in Textile Finishing

A bleached, unfinished woven PES/CO 65/35 twill fabric having a basis weight of 200 g/m² (fabric 1) and an unfinished 100% CO cretonne knit having a basis weight of 230 g/m² (fabric 2) were used for textile finishing. The comparison was again a finish with a 33% standard silicone softener emulsion (microemulsion of an amino−functional polydimethylsiloxane=control), commercially available from Wacker-Chemie GmbH under the trade name of Finish CT 34 E, and also water-padded and dried fabric (=blank test).

The fabric was saturated with the respective liquor, squeezed off to a 70% wet pickup using a two-roll mangle, tented and dried in a Mathis laboratory tenter at 150° C. for two minutes. The fabric was then conditioned at 23° C. and 50% relative humidity for at least 12 hours.

### Determination Methods for the Results of the Performance Examples:

### Determination of Softness (Hand Assessment):

Since the softness of textiles is greatly dependent on the subjective feel of the tester, only the boundary conditions can be standardized and not the assessment itself. To ensure reproducibility nonetheless, the finished samples were assessed and ranked in order with regard to their softness. To this end, 10 testers awarded 1 to n points to n tested samples, n points being awarded to the softest sample and 1 point to the least soft sample. The reported result is accordingly the average value of points scored by each sample.

### Determination of Droplet Absorption Time:

After finishing, the finished sample was conditioned at 23° C. and 50% relative humidity for eight hours before a droplet of deionized water was placed on the taut fabric surface from a height of 6 cm and the time taken for the droplet of water to be absorbed by the fabric was determined, three minutes being the longest time allowed. Five determinations were carried out and the results averaged.

Table 2 summarizes for some performance examples the results of the fabric finished by means of the padding process.

TABLE 2

| | | | | Blank | |
|---|---|---|---|---|---|
| | | | | test | |
| Use examples | 12a | 12b | 12c | (untreated) | Control |
| Example 7 | 5 g/l | — | 3 g/l | — | — |
| Example 10 | — | 5 g/l | 2 g/l | — | — |
| 33% standard | — | — | — | — | 15 g/l |
| silicone | | | | | |
| microemulsion | | | | | |
| Glacial acetic acid | 0.5 g/l | 0.5 g/l | 0.5 g/l | 0.5 g/l | 0.5 g/l |
| Droplet absorption | 50 | 3 | 15 | 108 | >180 |
| time(s) of fabric 1 | | | | | |
| Droplet absorption | 3 | <1 | 1 | 2 | >180 |
| time(s) of fabric 2 | | | | | |
| Hand of fabric 1 | 4.6 | 2.1 | 3.2 | 0 | 4.1 |
| Hand of fabric 2 | 4.5 | 2 | 3.3 | 0 | 4.1 |

Compared with the untreated fabrics and the fabrics treated with a standard silicone emulsion, softness and water absorption are appreciably improved by the siloxane copolymers used according to the present invention.

### Example 13

### Tissue Application

The inventive aqueous dispersions of Preparation Examples 7 and 10 and also their mixture (75% of Example 7+25% of Example 10) were tested for softness and absorbency on tissue paper against the Wacker standard products Finish CT 34 E (=comparison 4) and WETSOFT® CTA (=comparison 3).

To this end, the tissue paper was uniformly coated with 1.7% of the respective active silicone ingredient (0.85% each side) . Application was via a three-roll coater. The emulsion under test is filled into a stock reservoir vessel and taken up by a gravure roll. The gravure roll transfers the emulsion to an application roll, which applies the emulsion uniformly to the paper. The paper moves on the carrier between the application roll and a contact roll. The process is repeated for coating the other side of the paper.

The tissue paper used in the test is a commercially available, highly absorbent and open-pored tissue style, so that the coated papers were virtually free of any differentiation with regard to absorbency.

### Testing of Softness:

A number of differently coated tissue papers were compared with each other and with an uncoated paper (blank value) by touching.

A tester compares 2 tissue papers of equal size with each other by handling with the fingers (skin contact), and decides which tissue paper has a softer and more pleasant feel, or whether there is no difference.

The softer paper scores 1 point, the worse paper 0 points, and if there is no tangible difference both papers get 0.5 points.

All coated tissue papers and the blank value are compared with each other according to this procedure.

In the assessment of Table 3, 5 papers coated with different products and the blank value were examined by altogether 4 judges; i.e., the product with the best softness can achieve a maximum of 20 points, while the worst possible score is 0 points.

### Droplet Test:

To determine the water uptake of a coated tissue paper, the so-called droplet test is carried out. To this end, the papers to be tested are clamped taut without creases in a frame (metal lid with tensioning ring), and a drop of water is buretted at a rate of 5 s/drop from a height of 1 cm onto the tissue paper to be tested.

The time is taken until the droplet of water has completely disappeared.

This test is carried out altogether 4 times (2 times per side) in various places of the tissue paper. The average of the 4 measurements is reported. The results are summarized in Table 3.

TABLE 3

| | | | | | 75% of | |
|---|---|---|---|---|---|---|
| | | | | | Example 7 | |
| | Blank | CTA | WR 1100 | | 25% of | |
| Silicone | value | (comparison | (comparison | Example | Example | |
| emulsion | (untreated) | 3) | 4) | 10 | 10 | Example 7 |
| Softness | 0 | 7.0 | 11.0 | 11.5 | 16.5 | 15.5 |
| Droplet | 1.1 | 1.7 | 1.6 | 1.4 | 1.2 | 1.3 |
| test | | | | | | |
| [in s] | | | | | | |

The two comparative products WR 1100 and CTA were distinctly inferior to the inventive siloxane copolymers of Examples 7 and 10 and their mixture with regard to softness. In the droplet test, i.e., in relation to a tissue paper's water uptake and absorbency, all the products were much of a muchness, but here too the inventive siloxane copolymers tended if anything to have a better water uptake than the comparative examples.

1-21. (canceled)

22. A method of modifying fibrous substrates, comprising contacting said fibrous substrate with at least one siloxane copolymer obtained by
reacting, in a first step, organopolysiloxane(s) (1) which have at least one silicon-bonded hydrogen atom per molecule, with substantially linear algometric or polymeric compounds (2) of the formula
R¹-(A-CₙH₂ₙ)ₘ-A¹-H (I)
where R¹ is a monovalent optionally substituted hydrocarbyl radical capable of hydrosilylation,
A is a bivalent polar organic radical selected from the group consisting of —O—, —C(O)—O—, —O—C(O)—, —O—C(O)—O—, —C(O)—NH—, —NH—C(O)—, urethane radicals, and urea radicals,
A¹ is a bivalent polar organic radical selected from the group consisting of —O—, —NH— and —NR′— where R′ is a monovalent hydrocarbyl radical of 1 to 18 carbon atoms,
n is an integer from 1 to 20, and
m is 0 or a positive integer,
to form a H-A¹-group-containing intermediate compound (4) and,
reacting, in a second step,
the resulting H-A¹-group-containing intermediate (4) with at least one organic compound (5) which has two or more isocyanate groups per molecule,
wherein the mole equivalents of isocyanate groups are less than or equal to the mole equivalents of isocyanate-reactive groups.

23. The method of claim 22, wherein the water content of the compounds (1) and (2) is lower than 2000 ppm, based on the total weight of compounds (1) and (2).

24. The method of claim 22, wherein the organic compound(s) (5) are reacted in amounts of 0.5 to 1.0 mol of isocyanate group per mole of H-A¹ group in the intermediate (4).

25. The method of claim 22, wherein at least one organopolysiloxane (1) has the formula
H_{g}R_{3-g}SiO(SiR₂O)ₒ(SiRHO)ₚSiR_{3-g}H_{g} (III)
where R in each occurrence is the same or different and is a monovalent optionally substituted hydrocarbyl radical having 1 to 18 carbon atoms per radical,
g is 0, 1 or 2,
o is 0 or an integer from 1 to 1500, and
p is 0 or an integer from 1 to 200,
with the proviso that there is at least one silicon-bonded hydrogen atom per molecule.

26. The method of claim 22, wherein at least one organopolysiloxane (1) is an α, ω-dihydrodiorganopolysiloxane.

27. The method of claim 22, wherein A and A¹ in the formula (I) are an oxygen atom —O—.

28. The method of claim 22, wherein at least one compound (2) is an aliphatically unsaturated alcohol of the formula
H₂C=CH-R²-(OCₙH₂ₙ)ₘ-OH (IV)
where R² is a bivalent hydrocarbyl radical of 1 to 10 carbon atoms.

29. The method of claim 22, wherein at least one compound (5) is a diisocyanate of the formula
O=C=N-R³-N=C=O (V)
where R³ is a bivalent hydrocarbyl radical having 4 to 40 carbon atoms per radical.

30. The method of claim 22, wherein the second step utilizes at least one further compound selected from the group consisting of the formulae
R⁴-(A-CₙH₂ₙ)ₘ-A¹-H (VII),
HO-R⁵-NR⁴-R⁵-OH (VIII),
HO-R⁵-NR⁴₂ (IX),
HO-R⁶(NR⁴₂)₂ (X),
HO-R⁷(NR⁴₂)₃ (XI),
(HO)₂R⁶-NR⁴₂ (XII), and
HNR⁴₂ (XIII)
where R⁴ is a hydrogen atom or an R radical which may optionally contain a nitrogen atom,
R⁵ is a bivalent hydrocarbyl radical having 1 to 10 carbon atoms per radical,
R⁶ is a trivalent organic radical having 1 to 100 carbon atoms per radical, which optionally contains one or more oxygen atoms, and
R⁷ is a tetravalent organic radical having 1 to 100 carbon atoms per radical, which optionally contains one or more oxygen atoms.

31. The method of claim 30, wherein organic compounds (5) are used in amounts of 0.5 to less than 1.0 mol of isocyanate group per mole of the total of isocyanate-reactive groups from intermediate (4) and compound(s) (7).

32. The method of claim 30, wherein organic compounds (5) are used in amounts of 0.8 to less than 1.0 mol of isocyanate group per mole of the total of isocyanate-reactive groups from intermediate (4) and compound(s) (7).

33. The method of claim 22, wherein the siloxane cpolymers have the formula
CH₂=CH-R³-(OCₙH₂ₙ)ₘ-OC(O)NH-R²-NHC(O)O[(CₙH₂ₙO)ₘ-R³-CH₂CH₂-R₂Sio(R₂SiO)ₒ-R₂SiO-CH₂CH₂-R³-(OCₙH₂ₙ)ₘ-OC(O)NH-R²-NHC(O)O]ₓ(CₙH₂ₙO)ₘ-R³-CH =CH₂ (IV)
where R in each occurrence is the same or different and is a monovalent, optionally substituted hydrocarbyl radical having 1 to 18 carbon atoms per radical,
R² is a bivalent hydrocarbyl radical of 1 to 10 carbon atoms,
R³ is a bivalent hydrocarbyl radical having 4 to 40 carbon atoms per radical,
n is an integer from 1 to 20,
m is equal to 0 or a positive integer,
o is 0 or an integer from 1 to 1500, and
x is 0 or an integer from 1 to 20.

34. The method of claim 22 wherein the siloxane copolymer is used in the form of an aqueous emulsion or microemulsion.

35. The method of claim 22, wherein textile sheet materials, fibers, or yarns are modified.

36. The method of claim 22, wherein the siloxane copolymers soften textile sheet materials or textiles.

37. The method of claim 36 , wherein the step of contacting occurs in a final rinse cycle of a washing machine.

38. The method of claim 22, wherein paper is modified.

39. The method of claim 22, wherein hair is modified.

40. The method of claim 22, wherein the siloxane copolymers are added to a hair shampoo, hair conditioner, or other haircare product.

41. The method of claim 22, wherein leather is modified.

42. The method of claim 22, wherein the siloxane copolymers are used in a coating or glaze.

43. A fibrous substrate, modified by the method of claim 22.

44. The fibrous substrate of claim 43, which comprises a textile sheet material, a fiber, a yarn, paper or leather.
